(19) United States
(12) Patent Application Publication
(10) Pub. No.: US 2011/0039155 A1
(43) Pub. Date: Feb. 17, 2011

(54) METHOD FOR PRODUCING POSITIVE ELECTRODE FOR NON-AQUEOUS ELECTROLYTE SECONDARY BATTERY AND NON-AQUEOUS ELECTROLYTE SECONDARY BATTERY

(76) Inventor: Masaki Deguchi, Hyogo (JP)

Correspondence Address: MCDERMOTT WILL & EMERY LLP, 600 13TH STREET, NW, WASHINGTON, DC, 20005-3096, US

(21) Appl. No.: 12/937,468

(22) PCT Filed: Nov. 19, 2009
(86) PCT No.: PCT/JP2009/006230

§ 371 Date: Oct. 12, 2010

(30) Foreign Application Priority Data
Jan. 16, 2009 (JP) 2009-008103

(51) Int. Cl. H01M 10/056

(52) U.S. Cl. 429/199; 429/188; 427/77

(57) ABSTRACT

An object of the invention is to inhibit the entry of LiOH and Li₂CO₃during production of a positive electrode, thereby improving the cycle characteristics, storage characteristics, and reliability of a non-aqueous electrolyte secondary battery. In a method for producing a positive electrode for a non-aqueous electrolyte secondary battery for achieving this object, first, a positive electrode is formed by supporting, on a positive electrode current collector, a positive electrode mixture layer including a lithium-containing composite oxide represented by general formula: LiₓM_{y}Me_{1-y}O_{2+δ} (wherein M represent at least one element selected from the group consisting of Ni, Co, and Mn, Me represents a metallic element different from M, x satisfies 0.98≦x≦1.10, y satisfies 0.9≦y≦y 1.0). Then, the obtained positive electrode is washed with a cleaning solution including an organoborane represented by general formula: BR¹R²R³ (wherein R¹ to R³ each independently represent an aryl group or alkyl group that may have a fluorine atom) and an aprotic solvent.

### TECHNICAL FIELD

The present invention relates to a non-aqueous electrolyte secondary battery and the positive electrode thereof, and more particularly relates to an improvement of a method for removing impurities from a positive electrode active material for a non-aqueous electrolyte secondary battery.

### BACKGROUND ART

In recent years, expectations are rising for lithium ion batteries and other non-aqueous electrolyte secondary batteries as driving power sources for a variety of electronic devices. Lithium ion batteries have a high capacity and a high energy density, and can be easily reduced in size and weight. For this reason, they are widely used as power sources for portable electronic devices such as mobile phones, personal digital assistants (PDAs), notebook personal computers, digital cameras, and portable game devices, for example. Furthermore, their applications as, for example, power sources installed in vehicles such as electric vehicles and hybrid vehicles, and uninterruptible power supplies have been developed.

A lithium ion battery includes a positive electrode including a positive electrode active material such as a lithium-containing composite oxide, a negative electrode including a negative electrode active material capable of absorbing and desorbing lithium, a separator separating the positive electrode and the negative electrode, and an electrolyte. As the lithium-containing composite oxide used as the positive electrode active material, LiCoO₂ is commonly used. In addition, LiNiO₂ and a lithium-nickel-based composite oxide represented by LiMNiCoO₂ (wherein M represents Al, Mn, Cu, Fe, or the like) described in Patent Document 1 have been recently proposed as high-capacity positive electrode active materials that can replace LiCoO₂.

However, lithium-containing composite oxides, in particular, lithium-nickel-based composite oxides produce by-products such as lithium hydroxide and lithium carbonate during baking. Lithium hydroxide reacts with an electrolyte such as ethylene carbonate to generate gas. Lithium carbonate is oxidatively decomposed at high temperature to generate gas. Therefore, when the above-described by-products remain in the positive electrode and enter into the battery, the generation of gas may cause battery expansion and electrode deformation. Such battery expansion and electrode deformation cause the deterioration of cycle characteristics and storage characteristics, and also lead to the failure of the battery and electrolyte leakage, resulting in reduced battery reliability.

Meanwhile, Patent Documents 2 to 4 disclose techniques for removing lithium hydroxide and lithium carbonate by washing a baked lithium-containing composite oxide, followed by drying.

### Citation List

### Patent Document

Patent Document 1: Japanese Laid-Open Patent Publication No. Hei 5-242891

Patent Document 2: Japanese Laid-Open Patent Publication No. 2003-17054

Patent Document 3: Japanese Laid-Open Patent Publication No. Hei 6-342657

Patent Document 4: Japanese Laid-Open Patent Publication No. Hei 10-270025

### DISCLOSURE OF THE INVENTION

### Problem to be Solved by the Invention

However, with the methods involving washing a baked lithium-containing composite oxide with water as in Patent Documents 2 to 4, an exchange reaction between Li⁺ ion and H⁺ ion tends to occur between the lithium-containing composite oxide and water. Such an exchange reaction also occurs with water remaining in the lithium-containing composite oxide prior to dehydration after washing. The Li⁺ ion thus leached into water becomes another factor in the precipitation of lithium hydroxide, and moreover, lithium hydroxide reacts with carbon dioxide in the air, thus causing production of lithium carbonate. In this way, washing of a lithium-containing composite oxide with water may lead to regeneration of lithium hydroxide and lithium carbonate, and has limitations in removing them.

It is an object of the present invention to inhibit the entry of lithium hydroxide and lithium carbonate during production of a positive electrode for a non-aqueous electrolyte secondary battery, thereby improving the cycle characteristics, storage characteristics, and reliability of the non-aqueous electrolyte secondary battery.

### Means for Solving the Problem

A method for producing a positive electrode for a non-aqueous electrolyte secondary battery according to one aspect of the present invention includes:

a positive electrode formation step of forming a positive electrode by supporting, on a positive electrode current collector, a positive electrode mixture layer including a lithium-containing composite oxide represented by general formula (1):

L iₓM_{y}Me_{1-y}O_{2+δ} (1)

wherein M represents at least one element selected from the group consisting of Ni, Co, and Mn, Me represents a metallic element different from M, x satisfies 0.98≦x≦1.10, y satisfies 0.9≦y≦1.0, and δ represents an oxygen deficiency or an oxygen excess; and

a washing step of washing the positive electrode with a cleaning solution including an organoborane and an aprotic solvent,

wherein the organoborane is represented by general formula (2) below:

BR¹R²R³ (2)

wherein R¹, R² and R³ each independently represent an aryl group that may have a fluorine atom or an alkyl group that may have a fluorine atom.

A non-aqueous electrolyte secondary battery according to another aspect of the invention includes:

a positive electrode including a lithium-containing composite oxide represented by general formula (1):

LiₓM_{y}Me_{1-y}O_{2+δ} (1)

wherein M, Mn, Me, x, y, and δ are as defined above;

a negative electrode;

a separator disposed between the positive electrode and the negative electrode; and

a non-aqueous electrolyte,

wherein the non-aqueous electrolyte includes an organoborane represented by general formula (2):

BR¹R²R³ (2)

wherein R¹, R² and R³ are as defined above.

### Effect of the Invention

With the present invention, lithium hydroxide and lithium carbonate can be efficiently removed from a positive electrode including a lithium-containing composite oxide represented by general formula (1). Therefore, the present invention makes it possible to highly suppress the entry of lithium hydroxide and lithium carbonate into the positive electrode and the battery, thereby obtaining a non-aqueous electrolyte secondary battery having excellent cycle characteristics, storage characteristics, and reliability.

### BRIEF DESCRIPTION OF THE DRAWING

FIG. 1 is a schematic cross-sectional view showing one embodiment of a non-aqueous electrolyte secondary battery.

### BEST MODE FOR CARRYING OUT THE INVENTION

A method for producing a positive electrode for a non-aqueous electrolyte secondary battery according to this embodiment includes:

a positive electrode formation step of forming a positive electrode by supporting, on a positive electrode current collector, a positive electrode mixture layer including a lithium-containing composite oxide represented by general formula (1):

LiₓM_{y}Me_{1-y}O_{2+δ} (1)

wherein M represents at least one element selected from the group consisting of Ni, Co, and Mn, Me represents a metallic element different from M, x satisfies 0.98≦x≦1.10, y satisfies 0.9≦y≦1.0, and δ represents an oxygen deficiency or an oxygen excess; and

a washing step of washing the positive electrode obtained in the positive electrode formation step with a cleaning solution including an organoborane represented by general formula (2):

BR¹R²R³ (2)

(wherein R¹, R² and R³ each independently represent an aryl group that may have a fluorine atom or an alkyl group that may have a fluorine atom) and an aprotic solvent.

It seems that adding an organoborane represented by general formula (2) (hereinafter, referred to as “organoborane (2)”) to lithium hydroxide and lithium carbonate forms a stable adduct. Accordingly, washing a positive electrode with a cleaning solution in which organoborane (2) is dissolved or dispersed in an aprotic solvent as in the production method of this embodiment enables capturing of lithium hydroxide and lithium carbonate remaining in the positive electrode into organoborane (2) as an adduct. Then, lithium hydroxide and lithium carbonate can be efficiently removed as the adduct of organoborane (2) from the positive electrode by removing the cleaning solution from the positive electrode.

Therefore, with the method for producing a positive electrode for a non-aqueous electrolyte secondary battery according to this embodiment, it is possible to highly suppress the entry of lithium hydroxide and lithium carbonate into the positive electrode and the battery, thereby improving the cycle characteristics, storage characteristics, and reliability of the non-aqueous electrolyte secondary battery.

In this embodiment, there may be a case where organoborane (2) remains in the positive electrode without being removed by washing of a positive electrode for a non-aqueous electrolyte secondary battery, and enters into the battery. However, even in such a case, the physical properties of the non-aqueous electrolyte secondary battery are unlikely to deteriorate. In addition, it seems that organoborane (2) that has entered into the battery is reduced in the negative electrode to form a stable coating on the negative electrode surface, and the thus formed coating strongly protects the negative electrode surface. Accordingly, it is possible to inhibit the side reaction between the non-aqueous electrolyte and the negative electrode active material that may cause a cycle degradation, thereby improving the cycle characteristics of the battery even further.

It is particularly preferable that the lithium-containing composite oxide represented by general formula (1) (hereinafter, referred to as “lithium-containing composite oxide (1)”) is a lithium-nickel-based composite oxide represented by general formula (3):

LiₓNi_{w}M′_{z}Me′_{1-(w+z)}O_{2+δ} (3)

wherein M′ represents at least one of Co and Mn, Me′ represents a metallic element different from M′, w satisfies 0.3≦w≦1.0, z satisfies 0≦z≦0.7, w+z satisfies 0.9≦(w+z)≦1.0, and x and δ are as defined above (hereinafter, referred to as “lithium-nickel-based composite oxide (3)”).

Lithium-nickel-based composite oxides, when washed with water, are particularly prone to an exchange reaction between Li⁺ ion and H⁺ ion, and lithium hydroxide and lithium carbonate tend to be generated. Therefore, the effect of improving the cycle characteristics, storage characteristics, reliability, and the like of the non-aqueous electrolyte secondary battery can be achieved more prominently by using the method for producing a positive electrode for a non-aqueous electrolyte secondary battery according to this embodiment when the positive electrode active material is lithium-nickel-based composite oxide (3).

Preferably, at least one of R¹, R² and R³ of organoborane (2) includes a fluorine atom. It is particularly preferable that organoborane (2) is tris(pentafluorophenyl)borane. In this case, the adduct formed by organoborane (2) being added to lithium hydroxide or lithium carbonate is more stable.

In order to allow organoborane (2) remaining in the positive electrode even after a washing process of the positive electrode to form a sufficient amount of coating on the negative electrode surface, the organoborane (2) content is 50 ppm or greater relative to the non-aqueous electrolyte of the non-aqueous electrolyte secondary battery in a mass ratio. Setting the organoborane (2) content in the above range makes it possible to sufficiently achieve the effect of improving the cycle characteristics of the battery.

Hereinafter, the method for producing a positive electrode for a non-aqueous electrolyte secondary battery, and a non-aqueous electrolyte secondary battery according to this embodiment will be described in detail, taking a lithium ion battery as an example.

### <Method for Producing Positive Electrode for Non-Aqueous Electrolyte Secondary Battery>

In the method for producing a positive electrode for a non-aqueous electrolyte secondary battery according to this embodiment, first, a positive electrode is formed by supporting, on a positive electrode current collector, a positive electrode mixture layer including lithium-containing composite oxide (1) (positive electrode formation step). Further, the positive electrode obtained in the above-described positive electrode formation step is washed with a cleaning solution containing organoborane (2) and an aprotic solvent (washing step).

### (a) Positive Electrode Formation Step

In lithium-containing composite oxide (1) used in the positive electrode formation step, the atomic ratio of Li represented by x is 0.98 or greater and 1.10 or less, preferably, 0.98 or greater and 0.99 or less.

The element represented by M may be, for example, Ni, Co, or Mn. M may include only one of these elements, or may include a combination of two or three. It is preferable that M includes Ni, and a combination of Ni and Co is particularly preferable.

The atomic ratio of M represented by y is 0.9 or greater and 1.0 or less, preferably, 0.95 or greater and 0.98 or less.

Examples of the element represented by Me include metallic elements, and more specifically, elements belonging to any of Groups 1 to 14 of the periodic table (IUPAC, 1989), excluding Ni, Co, and Mn. Me may include only one of these elements, or may include a combination of two or more. Of the examples listed above, Me is preferably Al, Cr, Fe, Mg, or Zn, more preferably Mg or Al, particularly preferably Al.

The atomic ratio of Me represented by 1−y is 0 or greater and 0.1 or less, preferably 0.02 or greater and 0.05 or less.

Ordinarily, the oxygen deficiency or oxygen excess represented by δ is ±1% of the stoichiometric composition. That is, δ is preferably −0.01 or greater and +0.01 or less.

As described above, it is preferable that M includes Ni. That is, it is preferable that lithium-containing composite oxide (1) in this embodiment is a lithium-nickel-based composite oxide represented by general formula (3).

In lithium-nickel-based composite oxide (3), the ranges of the atomic ratio of Li represented by x and the oxygen deficiency or oxygen excess represented by δ are the same as in the case of lithium-containing composite oxide (1).

The atomic ratio of Ni represented by w is 0.3 or greater and 1.0 or less, preferably 0.7 or greater and 0.9 or less. When the atomic ratio of Ni is less than 0.3, the effect resulting from including nickel in the lithium-containing composite oxide, that is, the effect of further increasing the capacity of the lithium-containing composite oxide cannot be obtained sufficiently.

The element represented by M′ may be, for example, Co or Mn. M′ may include only one of Co or Mn, or include both Co and Mn.

The atomic ratio of M′ represented by z is 0 or greater and 0.7 or less, preferably 0.05 or greater and 0.25 or less.

Examples of the element represented by Me′ include those shown as the examples of Me in lithium-containing composite oxide (1). Me′ may include only one of the above-described elements, or may include a combination of two or more. Me′ is preferably Al, Cr, Fe, Mg, or Zn, more preferably Mg or Al, particularly preferably Al.

The atomic ratio of Me' represented by 1−w−z is 0 or greater and 0.7 or less, preferably 0 or greater and 0.1 or less, more preferably 0.02 or greater and 0.05 or less.

Specific examples of lithium-containing composite oxide (1) include, but are not limited to, compounds represented by formulae (1-1) to (1-6) below.

| | |
|---|---|
| LiNi_{0.8}Co_{0.15}Al_{0.05}O₂ | (1-1) |
| LiNi_{0.5}Co_{0.2}Mn_{0.3}O₂ | (1-2) |
| LiNi_{1/3}Co_{1/3}Mn_{1/3}O₂ | (1-3) |
| LiMn₂O₄ | (1-4) |
| LiCoO₂ | (1-5) |
| LiCo_{0.98}Mg_{0.02}O₂ | (1-6) |

Of the above compounds, the compounds represented by formulae (1-1) to (1-3) belong also to lithium-nickel-based composite oxide (3).

Lithium-containing composite oxide (1) can be produced by various known methods. For example, lithium-containing composite oxide (1) can be produced by baking a compound containing elements represented by M and Me in general formula (1) and a lithium compound.

Examples of the compound containing elements represented by M and Me include hydroxides, oxides, carbonates, and oxalates containing elements represented by Ni, Co, Mn, Al, Cr, Fe, Mg, Zn, and the like. These compounds contain one of the elements represented by M and Me, or may contain two or more of them. These compounds are available as commercial products, or can be produced according to various known methods.

Examples of the lithium compound include lithium hydroxide, lithium carbonate, lithium nitrate, and lithium peroxide. Of the above-mentioned lithium compounds, lithium hydroxide or lithium carbonate is particularly preferable in the case of producing lithium-nickel-based composite oxide (3). Further, these lithium compounds are available as commercial products, or can be produced according to various known methods.

There is no particular limitation with respect to the conditions for baking a compound containing elements represented by M and Me and a lithium compound, and various known baking conditions can be employed. For example, the baking temperature can be set in the range of approximately 650 to 900° C. The baking of a compound containing elements represented by M and Me and a lithium compound may be performed by multi-stage baking.

Examples of the baking atmosphere include ambient atmosphere and oxygen atmosphere. At the time of synthesizing a lithium-nickel-based composite oxide, it is preferable to increase the oxygen partial pressure of the baking atmosphere with an increase in the nickel content. Additionally, it is preferable that the baking atmosphere contains substantially no carbon dioxide, and it is more preferable that the dew point is −20° C. or less.

For example, various current collectors used for the positive electrode of a lithium ion battery can be used as the positive electrode current collector for supporting the positive electrode mixture layer. Therefore, there is no particular limitation, but a current collector formed of, for example, aluminum, an aluminum alloy, or the like is preferable. In general, the thickness of the positive electrode current collector is 5 to 100 μm, but is not limited thereto.

The positive electrode includes the above-described positive electrode current collector and a positive electrode mixture layer formed on the surface of the positive electrode current collector. The positive electrode mixture layer includes a positive electrode active material containing lithium-containing composite oxide (1), a positive electrode binder, and as needed, a positive electrode conductive agent.

Examples of the positive electrode binder include various known binders such as polyvinylidene fluoride, polytetrafluoroethylene, styrene-butadiene rubber, and carboxymethyl cellulose.

Examples of the positive electrode conductive agent include graphites such as natural graphite and artificial graphite, carbon blacks such as acetylene black, and conductive fibers such as carbon fiber and metal fiber.

The positive electrode mixture layer can be produced by various known methods. For example, first, a positive electrode active material containing lithium-containing composite oxide (1) is mixed with a positive electrode conductive agent, a positive electrode binder, and the like, as needed, and the resultant mixture is dispersed or dissolved in a liquid component. Then, a positive electrode mixture layer can be produced by applying the resultant dispersion or solution to the surface of the positive electrode current collector, followed by drying.

Examples of the liquid component include N-methyl-2-pyrrolidone, acetone, methyl ethyl ketone, tetrahydrofuran, dimethylformamide, dimethylacetamide, tetramethylurea, and trimethyl phosphate.

### (b) Washing Step

The cleaning solution used for the washing step contains organoborane (2) and an aprotic solvent.

R¹, R² and R³ of organoborane (2) may be, for example, an aryl group that may have a fluorine atom or an alkyl group that may have a fluorine atom. These R¹, R² and R³ may be the same substituent, or may be different from each other.

The aryl group that may have a fluorine atom has preferably 6 to 12 carbon atoms. Examples of C₆₋₁₂ aryl groups include a phenyl group, a tolyl group, a xylyl group, a cumenyl group, and a naphthyl group. Of these, a phenyl group is particularly preferable.

The alkyl group that may have a fluorine atom has preferably 1 to 4 carbon atoms. Examples of C₁₋₄ alkyl groups include a methyl group, an ethyl group, an n-propyl group, an isopropyl group, an n-butyl group, and a t-butyl group. Of these, a methyl group, an ethyl group, an n-propyl group, and an isopropyl group are particularly preferable.

Specific examples of organoborane (2) where R¹, R², and R³ are an alkyl group or an aryl group include triphenylborane, ethyldiphenylborane, methyldiphenylborane, diethylphenylborane, tri(p-tolyl)borane, and tri(α-naphthyl)borane.

Preferably, at least one of R¹, R² and R³ is a fluoroaryl group or a fluoroalkyl group. That is, organoborane (2) is preferably a fluorinated organoborane. The fluoroaryl group is preferably a fluorophenyl group such as pentafluorophenyl, 2,4,6-trifluorophenyl, 2-fluorophenyl, and 4-fluorophenyl. The fluoroalkyl group is preferably trifluoromethyl, pentafluoroethyl, hexafluoroisopropyl, or the like.

Preferable embodiments of the fluorinated organoborane include tris(fluorophenyl)borane represented by general formula (21), bis(fluorophenyl)phenylborane represented by general formula (22), diphenyl(fluorophenyl)borane represented by general formula (23), tris(fluoroalkyl)borane represented by general formula (24), bis(fluoroalkyl)alkylborane represented by general formula (25), dialkyl(fluoroalkyl)borane represented by general formula (26), and a fluorinated organoborane represented by general formula (27).

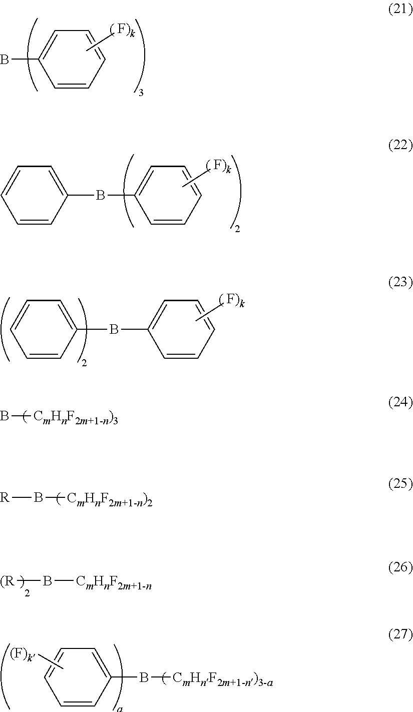

In general formulae (21) to (27) above, k represents an integer of 1 to 5, R represents a 0_{1—}4 alkyl group, m represents an integer of 1 to 4, n represents an integer of 0 to 2m, k′ represents an integer of 0 to 5, n′ represents an integer of 0 to 2m+1, and a represents 1 or 2, provided that k′ and n′ do not simultaneously represent k′=0 and n′=2m+1.

Examples of tris(fluoroaryl)borane of general formula (21) include tris(pentafluorophenyl)borane (TPFPB; [21-1]), tris(2-fluorophenyl)borane [21-2], tris(4-fluorophenyl)borane [21-3], tris(2,6-difluorophenyl)borane, tris(2,4,6-trifluorophenyl)borane [21-4], and bis(2-fluorophenyl)-4-fluorophenylborane. Note that the numbers shown in [ ] are assigned to the compounds used in the examples described below (the same applies to the following).

Examples of bis(fluoroaryl)phenylborane of general formula (22) include bis(2-fluorophenyl)phenylborane [22-1], bis(4-fluorophenyl)phenylborane [22-2], and bis(pentafluorophenyl)phenylborane [22-3].

Examples of diphenyl(fluoroaryl)borane of general formula (23) include diphenyl(2-fluorophenyl)borane [23-1], diphenyl(4-fluorophenyl)borane [23-2], diphenyl(2,6-difluorophenyl)borane, diphenyl(2,4,6-trifluorophenyl)borane, and diphenyl(pentafluorophenyl)borane [23-3].

Examples of tris(fluoroalkyl)borane of general formula (24) include tris(trifluoromethyl)borane [24-1], tris(pentafluoroethyl)borane [24-2], tris(hexafluoropropyl)borane [24-3], tris(hexafluoroisopropyl)borane [24-4], tris(heptafluoroisopropyl)borane, bis(trifluoromethyl)-fluoromethylborane, and bis(trifluoromethyl)-pentafluoroethylborane.

Examples of bis(fluoroalkyl)alkylborane of general formula (25) include bis(trifluoromethyl)methylborane [25-1], bis(pentafluoroethyl)methylborane [25-2], and pentafluoroethyl-(trifluoromethyl)methylborane [25-3].

Examples of dialkyl(fluoroalkyl)borane of general formula (26) include dimethyl(trifluoromethyl)borane [26-1], and diethyl(trifluoroethyl)borane [26-2].

Examples of the fluorinated organoborane of general formula (27) include dimethyl(pentafluorophenyl)borane [27-1], and diethyl(pentafluorophenyl)borane [27-2].

Of these organoboranes (2), TPFPB [21-1] is particularly preferable. TPFPB is highly capable of forming a stable adduct by being added to lithium hydroxide and lithium carbonate on the positive electrode surface, and therefore is particularly preferable for use in washing a lithium-containing composite oxide.

Organoboranes (2) shown above as examples may be used alone or in a combination of two or more.

Examples of the aprotic solvent include N-substituted amides, N-substituted ureas, sulfoxides, sulfolanes, nitriles, carbonic acid esters, and cyclic ethers.

Examples of N-substituted amides include N-methylformamide, N-methylacetamide, N-methylpropionamide, N,N-dimethylformamide, N,N-diethylformamide, N,N-dimethylacetamide, N-methyl-2-pyrrolidone, N-cyclohexyl pyrrolidone, and N-methylcaprolactam. Examples of N-substituted ureas include N,N,N′,N′-tetramethylurea, N,N′-dimethylimidazolidinone, N,N′-dimethylethyleneurea, and N,N′-dimethylpropyleneurea. Examples of sulfoxides include dimethyl sulfoxide and tetramethylene sulfoxide. Examples of sulfolanes include sulfolane and dimethylsulfolane. Examples of nitriles include acetonitrile and propiononitrile. Examples of carbonic acid esters include propylene carbonate and ethylene carbonate. Examples of cyclic ethers include dioxane (1,4-, 1,2-, or 1,3-dioxane). Of the examples shown above, propylene carbonate is particularly preferable as the aprotic solvent.

The concentration of organoborane (2) in the cleaning solution, as the amount of organoborane (2) in mol per liter of the cleaning solution, is preferably 0.01 to 0.2 mol/L, more preferably 0.05 to 0.1 mol/L. When the concentration of organoborane (2) is less than the above range, the effect of removing lithium hydroxide and lithium carbonate from the positive electrode may not be achieved sufficiently. On the other hand, adding organoborane (2) into the cleaning solution in an amount exceeding the above-described concentration does not improve the effect of removing lithium hydroxide and lithium carbonate from the positive electrode. Rather, it leads to the precipitation of organoborane (2) in the cleaning solution and a cost increase.

The positive electrode can be washed, for example, by immersing the positive electrode including a positive electrode current collector and a positive electrode mixture layer including lithium-containing composite oxide (1) in a cleaning solution and allowing it to stand for 0.5 to 2 hours, while stirring the cleaning solution as needed. The temperature of the cleaning solution is preferably 10 to 45° C., more preferably 20 to 30° C.

After the above-described washing with the cleaning solution, the positive electrode is subjected, as needed, to the second washing for rinsing off the cleaning solution. For example, an aprotic solvent that does not contain organoborane (2) may be used as the cleaning solution in the second washing. To simplify the drying process after washing, it is preferable to use the aprotic solvent used as the non-aqueous solvent of the non-aqueous electrolyte as the cleaning solution in the second washing.

As described above, organoborane (2) is unlikely to cause the deterioration of the physical properties of the non-aqueous electrolyte secondary battery even if it remains in the positive electrode without being removed and has entered into the battery. Rather, organoborane (2) is reduced in the negative electrode to form a coating on the negative electrode surface, thereby exhibiting the action of improving the cycle characteristics of the battery. Therefore, it is also possible to intentionally allow organoborane (2) contained in the cleaning solution used for the washing process of the positive electrode to remain in the positive electrode.

To allow organoborane (2) to form a coating on the negative electrode surface, the amount of organoborane (2) remaining in the washed positive electrode is adjusted so that organoborane (2) is contained in the non-aqueous electrolyte of the non-aqueous electrolyte secondary battery at a predetermined proportion. The proportion of organoborane (2) contained in the non-aqueous electrolyte will be described later.

### <Non-Aqueous Electrolyte Secondary Battery>

A non-aqueous electrolyte secondary battery according to this embodiment contains a lithium-containing composite oxide obtained by using the production method of this embodiment as the positive electrode active material.

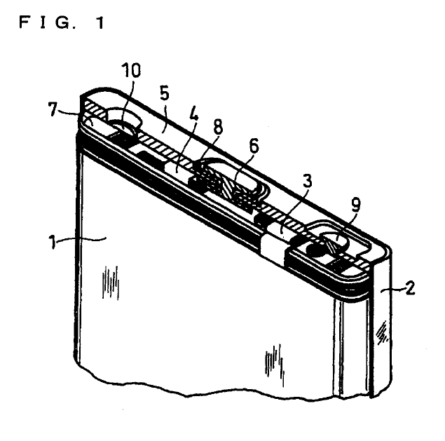

FIG. 1 is a partially cut-out perspective view of a non-aqueous electrolyte secondary battery according to this embodiment. Referring to FIG. 1, the non-aqueous electrolyte secondary battery includes an electrode group 1 formed by winding a positive electrode, a negative electrode, and a separator separating the positive electrode and the negative electrode. The electrode group 1 is housed in a battery case 2, together with a non-aqueous electrolyte (not shown). A positive electrode lead 3 connected to the positive electrode is provided at one end, in the winding direction (longitudinal direction), of the electrode group 1, and a negative electrode lead 4 connected to the negative electrode is provided at the other end.

The positive electrode lead 3 is connected to a sealing plate 5 sealing the battery case 2 at the end of the opening of the battery case 2. The sealing plate 5 is also used as a positive electrode-side external connection terminal. The negative electrode lead 4 is connected to a negative electrode-side external connection terminal 6 at the end of the opening of the battery case 2.

An insulating plate 7 separating the electrode group 1 and the sealing plate 5 and also separating the positive electrode lead 3 and the negative electrode lead 4 is placed in the battery case 2. The negative electrode-side external connection terminal 6 is placed in a through-hole formed in the sealing plate 5 serving as the positive electrode-side external connection terminal, and the sealing plate 5 and the negative electrode-side external connection terminal 6 are separated by an insulating packing 8. The sealing plate 5 also includes a non-aqueous electrolyte inlet and a cap 9 for sealing the inlet, as well as a battery safety valve 10.

The positive electrode includes a positive electrode current collector and a positive electrode mixture layer formed on the positive electrode current collector. A positive electrode that has been washed by the washing method of this embodiment is used as this positive electrode. The positive electrode current collector and the positive electrode mixture layer are the same as those described above.

The negative electrode include a negative electrode current collector and a negative electrode mixture layer formed on the negative electrode current collector.

Various current collectors used for negative electrodes of lithium ion batteries may be used as the negative electrode current collector without limitations. Specific examples thereof include metal foil made of metal such as stainless steel, nickel, copper, or titanium, and a thin film made of carbon, a conductive resin, or the like. These negative electrode current collectors may be subjected to surface treatment with carbon, nickel, titanium, or the like. In general, the thickness of the negative electrode current collector is 5 to 100 μm.

The negative electrode mixture layer includes a negative electrode active material capable of absorbing and desorbing lithium ions, and as needed, a negative electrode conductive agent and a negative electrode binder.

The negative electrode active material may be various negative electrode active materials used for non-aqueous electrolyte secondary batteries. Therefore, examples thereof include, but not particularly limited to, carbon materials such as graphite and amorphous carbon, a simple substance of silicon or tin, an alloy or a solid solution containing silicon or tin, or a composite material thereof.

Examples of the negative electrode conductive agent include the conductive agents shown as examples of the positive electrode conductive agent. Examples of the negative electrode binder include the binders shown as examples of the positive electrode binder.

Examples of the separator include a microporous thin film, woven fabric or non-woven fabric, and materials having high ion permeability, predetermined mechanical strength, and insulating property. In particular, a microporous film made of polyolefin such as polypropylene and polyethylene exhibiting high durability and having shut-down function is preferable in view of improving the reliability of the non-aqueous electrolyte secondary battery. In general, the thickness of the separator is 10 μm or greater and 300 μm or less, preferably 10 μm or greater and 40 μm or less.

The non-aqueous electrolyte includes, for example, a lithium salt, a non-aqueous solvent, and organoborane (2).

Examples of the non-aqueous solvent include aprotic organic solvents including, for example, carbonic acid esters such as ethylene carbonate, propylene carbonate, dimethyl carbonate, and ethylmethyl carbonate, ethers such as tetrahydrofuran and 1,3-dioxolane, and carboxylic acid esters such as γ-butyrolactone. These non-aqueous solvents may used alone or in a combination of two or more.

Examples of the lithium salt include various lithium salts such as LiPF₆.

Organoborane (2) can be included in the non-aqueous electrolyte by producing the positive electrode by the production method of this embodiment. In the washing step in the production method of this embodiment, the positive electrode is washed with a cleaning solution containing organoborane (2) and an aprotic solvent. After this washing step, organoborane (2) remains in the positive electrode. Organoborane (2) remaining in the positive electrode is dissolved or dispersed in the non-aqueous electrolyte during assembly of the non-aqueous electrolyte secondary battery.

As described above, organoborane (2) forms a coating on the surface of the negative electrode, thereby improving the cycle characteristics of the non-aqueous electrolyte secondary battery.

Therefore, in order to sufficiently achieve the effect of improving the cycle characteristics, the amount of organoborane (2) that results from the above-described washing step and is contained in the non-aqueous electrolyte is 1500 ppm or less, preferably 50 to 500 ppm. When the amount of organoborane (2) in the non-aqueous electrolyte is less than 50 ppm, the above-described coating may not be formed on the negative electrode surface.

Referring again to FIG. 1, the non-aqueous electrolyte secondary battery can be obtained by housing the negative electrode, the positive electrode, the separator, and the non-aqueous electrolyte in the battery case 2, together with the positive electrode lead 3, the negative electrode lead 4, the insulating plate 7, and so forth, and hermetically sealing the battery case 2 by the sealing plate (positive electrode external connection terminal) 5, the negative electrode external connection terminal 6, and the insulating packing 8. Specifically, first, the positive electrode, the negative electrode, and the separator separating the two electrodes are wound to give a spiral electrode group 1. Subsequently, the electrode group 1 is housed in the battery case 4 such that the positive electrode lead 2 attached to the positive electrode and the negative electrode lead 3 connected to the negative electrode each extend toward the end of the opening of the battery case 4. Thereafter, the opening of the battery case 4 is sealed by the sealing plate 5. The positive electrode lead 2 is brought into contact with the surface of the sealing plate 5 on the inside of the battery case 4, and the negative electrode lead 3 is brought into contact, from the inside of the battery case 4, with the negative electrode external connection terminal 6 disposed in the through-hole in the sealing plate 5 via a gasket 7. Further, the non-aqueous electrolyte is injected from the inlet provided on the sealing plate 5, and the inlet is thereafter sealed by the sealing material 8.

Although an application to the wound prismatic non-aqueous electrolyte secondary battery was shown in the above description, the shape of the non-aqueous electrolyte secondary battery is not limited thereto. The shape may be selected from various shapes including, for example, a coin shape, a cylindrical shape, a sheet shape, a button shape, a flat shape, and a laminated shape according to the use of the non-aqueous electrolyte secondary battery.

### Examples

### Example 1

### (1) Fabrication of Positive Electrode

1 kg of lithium-containing composite oxide (LiNi_{0.80}Co_{0.15}Al_{0.05}O₂) powder, 0.5 kg of an N-methyl-2-pyrrolidone (NMP) solution of polyvinylidene fluoride (manufactured by KUREHA CORPORATION, #1320, solid content concentration: 12 wt %), and 40 g of acetylene black were placed in a double arm kneader together with a proper amount of NMP, and stirred at 30° C. for 30 minutes to prepare a positive electrode mixture paste. The obtained positive electrode mixture paste was applied to both sides of a 20 μm thick aluminum foil serving as the positive electrode current collector, and dried at 120° C. for 15 minutes to produce a positive electrode mixture layer. Further, the positive electrode current collector and the positive electrode mixture layer were pressed with a roll press to a total thickness of 160 μm, thereby giving a positive electrode. The thus obtained positive electrode was cut and shaped into an appropriate size to be housed in a prismatic battery case with a height of 50 mm, a width of 34 mm, and a thickness of 5 mm. A positive electrode lead was attached to a part of the positive electrode.

### (2) Washing of Positive Electrode Plate

### Preparation of Cleaning Solution

To 100 mL of propylene carbonate (PC) was added 5.1 g of tris(pentafluorophenyl)borane [TPFPB; 21-1] as organoborane (2), and stirred and dissolved to prepare a cleaning solution (TPFPB/PC electrolyte solution). The TPFPB concentration in this cleaning solution was 0.1 mol/L.

### Washing Process

The positive electrode plate was placed in a 50 mL beaker in a rolled state, and approximately 50 mL of the cleaning solution (TPFPB/PC electrolyte solution) was additionally injected. Then, the positive electrode plate was kept still for one hour while being immersed in the cleaning solution (room temperature: 25° C.). After being kept still, the positive electrode plate was removed from the cleaning solution. Then, the positive electrode plate that had undergone the washing process was placed in the 50 mL beaker in a rolled state, and approximately 50 mL of propylene carbonate (PC) was injected. Then, the positive electrode plate was kept still for 5 minutes with slight stirring, while being immersed in PC, and thereafter PC was removed. This operation was repeated 3 times to rinse off TPFPB from the positive electrode plate. Further, the positive electrode plate that had undergone the rinsing process was vacuum-dried under an atmosphere at a temperature of 85° C. and an air pressure of 1 mmHg for 10 minutes to remove the PC solvent. Thus, the washing of the positive electrode was completed.

### (3) Fabrication of Negative Electrode

3 kg of artificial graphite, 200 g of a dispersion of modified styrene-butadiene rubber (manufactured by ZEON Corporation, BM-400B, solid content: 40 wt %), and 50 g of carboxymethyl cellulose were placed in a double arm kneader together with a proper amount of water and stirred to prepare a negative electrode mixture paste. The obtained negative electrode mixture paste was applied to both sides of a 12 μm thick copper foil serving as a negative electrode current collector, and dried at 120° C. Further, the negative electrode current collector and the negative electrode mixture layer were rolled with a roll press to a total thickness of 160 μm. The thus obtained negative electrode was cut and shaped to an appropriate size to be housed in the above-described battery case. A negative electrode lead was attached to a part of this negative electrode.

### (4) Preparation of Non-Aqueous Electrolyte

Ethylene carbonate and dimethyl carbonate were mixed in a volume ratio of 1:3 to prepare a non-aqueous solvent. LiPF₆ was added to this non-aqueous solvent and dissolved to give a non-aqueous electrolyte (non-aqueous liquid electrolyte) with a LiPF₆ having a concentration of 1.4 mol/m³. Further, for the purpose of increasing the charge/discharge efficiency of the battery, vinylene carbonate serving as an additive was added to the non-aqueous electrolyte. The proportion of vinylene carbonate contained was adjusted to 5 wt % of the entire non-aqueous solvent.

### (5) Production of Non-Aqueous Electrolyte Secondary Battery

The positive electrode including a positive electrode lead, the negative electrode including a negative electrode lead, and the electrolyte described above were used to produce a prismatic non-aqueous electrolyte secondary battery as shown in FIG. 1. A composite film of polyethylene and polypropylene (manufactured by Celgard Inc., product number: “2300”, thickness: 25 μm) was used as the separator. This non-aqueous electrolyte secondary battery was a prismatic battery with a height of 50 mm, a width of 34 mm, and a thickness of 5 mm, and the design capacity was 900 mAh.

### Examples 2 to 21

Non-aqueous electrolyte secondary batteries were produced in the same manner as in Example 1 except that different cleaning solutions were used for the positive electrode plate washing process. Electrolyte solutions prepared by dissolving the respective organoboranes in 100 mL of propylene carbonate (PC), followed by stirring, were used as the cleaning solutions. The organoboranes used in the examples and the compound numbers are as follows.

Example 2: tris(2-fluorophenyl)borane [21-2]

Example 3: tris(4-fluorophenyl)borane [21-3]

Example 4: tris(2,4,6-trifluorophenyl)borane [21-4]

Example 5: bis(2-fluorophenyl)phenylborane [22-1]

Example 6: bis(4-fluorophenyl)phenylborane [22-2]

Example 7: bis(pentafluorophenyl)phenylborane [22-3]

Example 8: diphenyl(2-fluorophenyl)borane [23-1]

Example 9: diphenyl(4-fluorophenyl)borane [23-2]

Example 10: diphenyl(pentafluorophenyl)borane [23-3]

Example 11: tris(trifluoromethyl)borane [24-1]

Example 12: tris(pentafluoroethyl)borane [24-2]

Example 13: tris(hexafluoropropyl)borane [24-3]

Example 14: tris(hexafluoroisopropyl)borane [24-4]

Example 15: bis(trifluoromethyl)methylborane [25-1]

Example 16: bis(pentafluoroethyl)methylborane [25-2]

Example 17: pentafluoroethyl-(trifluoromethyl)methylborane [25-3]

Example 18: dimethyl(trifluoromethyl)borane [26-1]

Example 19: diethyl(trifluoroethyl)borane [26-2]

Example 20: dimethyl(pentafluorophenyl)borane [27-1]

Example 21: diethyl(pentafluorophenyl)borane [27-2]

### Comparative Example 1

A non-aqueous electrolyte secondary battery was produced in the same manner as in Example 1 except that the positive electrode plate washing process was not performed.

### Comparative Example 2

A non-aqueous electrolyte secondary battery was produced in the same manner as in Example 1 except that the cleaning solution used for the positive electrode plate washing process was 100 mL of propylene carbonate.

### Evaluation of Physical Properties of Non-Aqueous Electrolyte Secondary Batteries

### (i) Evaluation of Capacity Retention Rate and Battery Swelling

Each of the prismatic non-aqueous electrolyte secondary batteries obtained in Examples 1 to 21 and Comparative Example 1 was subjected to repeated charge/discharge cycles at 45° C. Then, the discharge capacity at the third cycle was regarded as 100%, and the discharge capacity after 500 cycles was expressed as a percentage and was used as the capacity retention rate [%]. The calculated results are shown in the column “Capacity retention rate” in Table 1.

Further, the thickness of a central portion of the largest plane (50 mm long, 34 mm wide) of the prismatic battery was measured in the state after the charge in the third cycle and the state after the charge in the 501st cycle, and the amount of battery swelling [mm] after charge/discharge cycles at 45° C. was determined from the difference in the battery thicknesses. The results of this measurement are shown in the column “Battery swelling after cycles”.

In the charging process of the above-described charge/discharge cycles, constant current/constant voltage charge was performed for two and a half hours with a maximum current of 630 mA and an upper voltage limit of 4.2 V. The rest period after charge was 10 minutes. Meanwhile, in the discharge process, constant current discharge was performed with a discharge current of 900 mA and an end-of-discharge voltage of 2.5 V. The rest period after discharge was 10 minutes.

### (ii) Quantitative Determination of Organoborane in Non-Aqueous Electrolyte Solution

Each of the prismatic non-aqueous electrolyte secondary batteries obtained in Examples 1 to 21 and Comparative Example 1 was subjected to three repeated charge/discharge cycles at 25° C. Thereafter, a cut was made using nippers in the sealing plate side edge of the prismatic battery in the discharged state, and the battery was centrifuged to extract the non-aqueous electrolyte (non-aqueous electrolyte solution) from the inside of the battery case. The thus extracted non-aqueous electrolyte was used as a test sample.

Then, the boron content in the extracted test sample was quantified by ICP emission spectral analysis (VISTA-RL manufactured by VARIAN), and the amount [ppm] of organoborane remaining in the non-aqueous liquid electrolyte was calculated based on the quantified result. The calculated results are shown in the column “Organoborane in electrolyte solution” in Table 1. The charge/discharge conditions were the same as those used for evaluation of the capacity retention rate.

TABLE 1

| | | | Evaluation of | | |
|---|---|---|---|---|---|
| | | | physical properties | | |
| | | | | Battery | Organoborane |
| | | | Capacity | swelling | in |
| | Positive | | retention | after | electrolyte |
| | electrode | Organo- | rate | cycles | solution |
| | washing step | borane | [%] | [mm] | [ppm] |
| Ex. 1 | Performed | 21-1 | 88.2 | 0.30 | 70 |
| Ex. 2 | Performed | 21-2 | 83.2 | 0.42 | 130 |
| Ex. 3 | Performed | 21-3 | 83.6 | 0.41 | 120 |
| Ex. 4 | Performed | 21-4 | 85.4 | 0.36 | 110 |
| Ex. 5 | Performed | 22-1 | 82.7 | 0.43 | 140 |
| Ex. 6 | Performed | 22-2 | 82.1 | 0.46 | 130 |
| Ex. 7 | Performed | 22-3 | 84.0 | 0.40 | 90 |
| Ex. 8 | Performed | 23-1 | 80.8 | 0.56 | 230 |
| Ex. 9 | Performed | 23-2 | 80.2 | 0.58 | 280 |
| Ex. 10 | Performed | 23-3 | 82.3 | 0.45 | 150 |
| Ex. 11 | Performed | 24-1 | 83.9 | 0.40 | 80 |
| Ex. 12 | Performed | 24-2 | 84.5 | 0.38 | 90 |
| Ex. 13 | Performed | 24-3 | 84.1 | 0.39 | 90 |
| Ex. 14 | Performed | 24-4 | 84.2 | 0.39 | 80 |
| Ex. 15 | Performed | 25-1 | 81.6 | 0.49 | 80 |
| Ex. 16 | Performed | 25-2 | 81.9 | 0.45 | 90 |
| Ex. 17 | Performed | 25-3 | 82.0 | 0.46 | 70 |
| Ex. 18 | Performed | 26-1 | 80.7 | 0.54 | 70 |
| Ex. 19 | Performed | 26-2 | 80.8 | 0.55 | 80 |
| Ex. 20 | Performed | 27-1 | 81.2 | 0.51 | 100 |
| Ex. 21 | Performed | 27-2 | 81.3 | 0.50 | 120 |
| Com. | Not | Not | 52.1 | 1.20 | 0 |
| Ex. 1 | performed | contained | | | |
| Com. | Performed*¹ | Not | 52.3 | 1.20 | 0 |
| Ex. 2 | | contained | | | |

*¹The cleaning solution in Comparative Example 2 did not contain organoborane (2).

The compound numbers assigned to organoboranes (2) are shown in the column “organoborane” in Table 1.

As is evident from Table 1, Examples 1 to 21, in which the positive electrodes were washed with cleaning solutions containing organoboranes (2) and PC, which is an aprotic solvent, it was possible to increase the capacity retention rate of the non-aqueous electrolyte secondary battery, and also to reduce the amount of battery swelling after cycles. Furthermore, in Examples 1 to 21 described above, organoboranes (2) remained at a rate of 50 ppm or greater in the non-aqueous liquid electrolytes after the batteries were assembled.

### INDUSTRIAL APPLICABILITY

The present invention can be suitably applied to non-aqueous electrolyte secondary batteries such as a lithium ion battery and a polymer electrolyte secondary battery. Furthermore, the invention is not limited to non-aqueous electrolyte secondary batteries for small devices, but is also effective for large and high-capacity secondary batteries such as a power source for electric vehicles and a power source for power storage.

1. A method for producing a positive electrode for a non-aqueous electrolyte secondary battery, comprising:
a positive electrode formation step of forming a positive electrode by supporting, on a positive electrode current collector, a positive electrode mixture layer comprising a lithium-containing composite oxide represented by general formula (1):
LiₓM_{y}Me_{1-y}O_{2+δ} (1)
wherein M represents at least one element selected from the group consisting of Ni, Co, and Mn, Me represents a metallic element different from M, x satisfies 0.98≦x≦1.10, y satisfies 0.9≦y≦1.0, and δ represents an oxygen deficiency or an oxygen excess; and
a washing step of washing said positive electrode with a cleaning solution comprising an organoborane and an aprotic solvent,
wherein said organoborane is represented by general formula (2):
BR¹R²R³ (2)
wherein R¹, R² and R³ each independently represent an aryl group that may have a fluorine atom or an alkyl group that may have a fluorine atom.

2. The method for producing a positive electrode for a non-aqueous electrolyte secondary battery in accordance with claim 1,
wherein said lithium-containing composite oxide is a lithium-nickel-based composite oxide represented by general formula (3):
LiₓNi_{w}M′_{z}Me′_{1-(w+z )}O_{2+δ} (3)
wherein M′ represents at least one of Co and Mn, Me′ represents a metallic element different from M′, x satisfies 0.98≦x≦1.10, w satisfies 0.3≦w≦1.0, z satisfies 0≦z≦0.7, w+z satisfies 0.9≦(w+z)≦1.0, and δ represents an oxygen deficiency or an oxygen excess.

3. The method for producing a positive electrode for a non-aqueous electrolyte secondary battery in accordance with claim 1, wherein at least one of R¹, R² and R³ in said general formula (2) has a fluorine atom.

4. The method for producing a positive electrode for a non-aqueous electrolyte secondary battery in accordance with claim 1, wherein said organoborane is tris(pentafluorophenyl)borane.

5. A non-aqueous electrolyte secondary battery comprising:
a positive electrode comprising a lithium-containing composite oxide represented by general formula (1):
LiₓM_{y}Me_{1-y}O_{2+δ} (1)
wherein M represents at least one element selected from the group consisting of Ni, Co, and Mn, Me represents a metallic element different from M, x satisfies 0.98≦x≦1.10, y satisfies 0.9≦y≦1.0, and δ represents an oxygen deficiency or an oxygen excess;
a negative electrode;
a separator disposed between said positive electrode and said negative electrode; and
a non-aqueous electrolyte,
wherein said non-aqueous electrolyte comprises an organoborane represented by general formula (2):
BR¹R²R³ (2)
wherein R¹, R² and R³ each independently represent an aryl group that may have a fluorine atom or an alkyl group that may have a fluorine atom.

6. The non-aqueous electrolyte secondary battery in accordance with claim 5, wherein said non-aqueous electrolyte comprises at least 50 ppm of said organoborane in a weight ratio.
